(19) United States
(12) Patent Application Publication
(10) Pub. No.: US 2011/0030145 A1
(43) Pub. Date: Feb. 10, 2011

(54) Insulating Hand Tool

(76) Inventor: Zeljko Mandic, Yarraville (AU)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 12/670,391

(22) PCT Filed: Jul. 18, 2008
(86) PCT No.: PCT/AU2008/001045

§ 371 Date: Oct. 21, 2010

(30) Foreign Application Priority Data
Jul. 23, 2007 (AU) 2007903960

(51) Int. Cl. B25B 7/22; B25B 7/02; B25B 25/00; B25G 1/12; B26B 17/00

(52) U.S. Cl. 7/107; 81/427.5; 81/421; 7/129; 7/130

(57) ABSTRACT

An insulating hand tool having handles of insulating material located at or towards one end of the hand tool capable of being grasped by a person using the hand tool and work elements located at or towards the another end of the hand tool at the nose or head of the tool wherein the work elements include a jaw insert retaining portion for receiving a replaceable cutting insert therein in such a manner to substantially insulate the cutter of the insert from the remainder of the tool to reduce the chance of injuring the person using the tool in the event the cutter contacts a live conductor. The insert is replaceable so that, should the insert be damaged in use, the damaged insert can be replaced by an exchange insert obviating the need to discard the entire tool since only the damaged insert need be replaced.

### FIELD OF THE INVENTION

The present invention relates generally to insulated hand tools.

In one form the present invention relates to insulated hand tools for use in severing or cutting materials.

In one form the present invention relates to insulated hand tools for installing fittings onto a conductor, including installing connectors and terminals on the end of wire cables or the like.

In one form the present invention relates to insulated hand tools which can be used to both cut or sever cables and to install fittings on cables.

In one form the present invention relates to insulated pliers.

In one aspect the present invention relates to replaceable or exchangeable cutters and/or inserts for being detachably mounted on insulating or insulated hand tools, such as pliers.

In one embodiment the present invention relates to an insert for being received at or towards the end of the jaw which insert can be replaced when damaged.

In one aspect, the present invention relates to insulated pliers having a replaceable or exchangeable cutter and/or insert having a cutter which can be readily renewed in the event of damage or wear to the cutter and/or insert.

Although the present invention will be described with particular reference to one form of the insulating pliers and of the replaceable insert of the present invention, it is to be noted that the scope of the present invention is not restricted to the described embodiment, but rather the scope of the present invention is more extensive so as to include other forms and arrangements of gripping implements and/or installing implements in the form of hand tools generally, other forms and arrangement of the insert, and pliers or cutters in particular, and to the use of a variety of gripping implements in situations where injury could occur to workmen using the tool in hazardous situations, particularly where there is a danger of a hand held tool coming into contact with a live electrical conductor carrying electrical current sufficiently powerful to injure a person.

### BACKGROUND OF THE INVENTION

Electrical contractors often are required to use gripping tools, such as for example, pliers or wire stripping tools to manipulate electrical conductors, such as wires and the like during installation and maintenance of electrical equipment, when repairing or renewing electrical installations and similar, including installing new electrical conductors into a new or existing electrical system and installing fittings onto conductors such as connectors, terminals and similar. Normally, pliers are made from metal owing to the toughness and durability required of the pliers, particularly the jaws of the pliers and the fulcrum of the pliers about which the two arms of the pliers pivot due to the high loads placed on the pliers by cutting conductors, such as power cables and similar. Such strength and durability is provided by using metals to make the pliers, including the cutters, so that electrical conductors in the form of wire, particularly heavy duty wires, cables or the like can be severed without undue difficulty. As pliers having metal jaws and handles can conduct electricity to the person holding the pliers, it is recommended that, and it is generally accepted as being best practice, for the safety of electrical contractors working on conductors and the electrical system for the power to be switched off before work on the conductors is commenced. Normally, when working on electrical installations, the power is disconnected before commencing work on the conductor to avoid the possibility of death and injury. However, sometimes situations arise in which the power is not disconnected, such as for example, due to operator error when there is a breach of safety regulations or where power is accidentally restored to the installation, even momentarily, such as for example, momentarily when testing the installation or for other reasons. There are other situations where it is not always possible to remove power from the conductor whilst working on the conductor, such as for example, in situations such as often encountered in hospitals when the removal of power in some situations could be life threatening for patients requiring power to operate life support and/or monitoring equipment where there is no ready replacement of the power by an alternative power source. Other situations could include emergencies where the consequences of removing power are even more catastrophic than the risk of electrocuting and/or injuring workmen or where because of other circumstances such as accidents, including motor vehicle accidents, industrial accidents, explosions or similar or failure of equipment it is not possible to interrupt the power using the switch as provided but rather it is often necessary to sever a live electrical wire to disrupt the power supply prior to being able to work safely in the accident zone. Thus, despite the safety regulations and the best intentions of all concerned which are to be followed at all times, there are some situations either through inadvertence or accident, where circumstances arise that cause a workman to work on an electrically live conductor, and in particular to cut the conductor to disrupt power. Often pliers or cutters are used to sever the live electrical conductor which can lead to damage being caused to the pliers, particularly the jaws or cutters provided at the end of the pliers rendering the pliers unusable so that they have to be discarded and replaced by new pliers which is a cost often borne by the workman.

In the past, metal pliers or cutters have been used to join conductors and to cut conductors where necessary. The jaws of such pliers need to be made of metal to be strong enough to be able to withstand the forces incurred when manipulating and severing the electrical wires. However, such pliers usually also have metal handles in electrical connection with the jaws so that if the metal jaws contact a live conductor there is a risk of current being conducted from the metallic jaws to the metal handles and hence to the person holding the pliers or cutters, often resulting in injury to the person, or sometimes death through electrocution.

In the past some attempts have been made to provide insulation on the handles by having plastic coating covering part of the handles of the pliers in an attempt to insulate the user from the metal parts of the pliers and hence from the risk of electrocution. However, previously available so called insulating pliers have suffered from one or more defects in that the pliers have had some metallic parts exposed, such as for example, the fulcrum of the pliers where the two movable arms or limbs of the pliers are pivotally connected to each other by a pin or similar fastener is left uncovered to allow the pliers to pivot or the sides of the metallic jaws are left exposed where there is a risk of contact, including inadvertent contact, by the fingers, thumb or hands of a workman using such pliers, such as for example, by placing the thumb against the exposed metal fulcrum of the pliers when using the pliers to strip insulation from the end of the wire to expose the wire prior to connecting the wire to another conductor or to part of the equipment or installation. Furthermore, the plastic insulation degrades over time by splitting or being cut to expose the bare metal handles underneath with the attendant risk of electrocution if the jaws come into contact with a live conductor whilst the exposed metal part of the pliers is in contact with the workman's hands or other part of the body.

Thus, for these and other reasons, previous attempts to coat pliers in plastic or to provide insulated handles of pliers have not been successful since existing pliers suffer from one or other disadvantage.

Therefore, there is a need to provide pliers which are safer to use than existing pliers and which have handles which are more durable and can withstand rough usage whilst providing better protection against injury and death caused by contact of the pliers with a live conductor.

Additionally, there is a need to prolong the useful working life of pliers by providing jaws which are longer lasting by having replaceable work elements connected to the jaws of the pliers.

Accordingly, one aim of the present invention is to provide pliers or similar tools having improved insulating properties so that there is less risk of injury or death from electrocution by electrical current being conducted to the handles of the pliers upon contact of the metal jaws of the pliers with a live electrical conductor when the pliers are held in the hands.

It is another aim of the present invention to provide pliers which are longer lasting by providing replaceable work elements that are damaged in preference to damage sustained by the jaws of the pliers.

### SUMMARY OF THE INVENTION

According to one aspect of the present invention, there is provided a hand held gripping tool having a first member and a second member pivotally connected to one another about a fulcrum allowing relative movement of the two members with respect to one another, each said member having an operative end and a handle portion arranged so that the respective operative ends move relatively closer together to each other in response to the movement of the handle portions relatively closer together wherein at least one of the operative ends includes an insert retaining portion for receiving an insert therein wherein the retaining portion is made from an electrically insulating material or is provided with an insulating cover arrangement so that if the insert when received in the retaining portion contacts a live electrical conductor, there is a reduced chance of live electrical current being conducted from the insert through the tool to the handle portion of either member thereby providing improved safety by protecting the person holding the hand tool against injury that could have been caused by contact with the live electrical conductor.

According to another aspect of the present invention there is provided an insert for a hand held tool comprising:

a main body portion having

a work element extending outwardly from the body portion for performing a work operation on material located adjacent the work element in use of the tool, and

a fastening arrangement for assisting in fastening the insert to the tool.

Preferably, the insert is also provided with a locating portion for locating the insert with respect to the tool such that the locating portion of the insert engages with a complementary locating element provided on the tool to correctly orient the insert with respect to the tool in a position in which at least a part of the work element of the insert is exposed for cutting.

BRIEF DESCRIPTION OF THE INVENTION

In one form, the hand tool of the present invention is essentially a hand held gripping tool. Examples of the hand held gripping tool are pliers, stripping tools, tweezers, locking pliers such as multigrips, clamps, tongs, forceps, shears, hand cutting tools, wire cutters, crimping tools, grips and similar tools. The hand held tools are cutting and/or severing tools or the like or are crimping and/or squeezing and/or clamping tools or the like or are tools having a combination of cutting and squeezing tools in which a part of the tool is for cutting and another part of the tool is for squeezing.

It is to be noted that the gripping tool of the present invention can take any form as indicated above. For simplicity of description and ease of understanding, the term pliers will be used to refer to the gripping tool generally. However, it is to be noted that pliers are one form only of the gripping tool and the use of the term pliers is not meant to be limiting, such as by restricting the scope of the invention to pliers only.

In one form, the two members, arms or limbs of the pliers connected together by the pivot or fulcrum are predominantly made from an insulating material or are substantially made from an insulating material, such as for example from a non conductive plastics material, including an engineering plastics material having sufficient strength, durability, rigidity and similar.

Examples of the plastics materials include engineering plastics such as polyamides, nylons, polyethylene, polypropylene, acrylonitrile butadiene styrene, polybutylene, polyvinyl chloride, polyvinylidene fluoride, chlorinated polyvinyl chlorides or other similar materials.

In another form, the two members, arms or limbs are at least partially or wholly made from metal and are provided with plastic handle extensions and/or plastic handle coverings, caps or coatings to insulate the handles or handle portions by enveloping or surrounding the metal parts with a suitable insulating material. The two members either being made of metal or containing metal components, have the metal components at strategic locations within the pliers so that the metal parts, or components, if provided, are not in electrical contact or continuity with each other in order to prevent conduction of current through the pliers. Moreover, the insert is insulated from the handles so as to be isolated from the remainder of the pliers, particularly the handles so that if the insert should touch a live electrical conductor, current is not conducted to the handles or to any other exposed metallic part of the pliers. Strategic locations of metallic components include the pivot or fulcrum about which the two members are pivotally connected to each other including bushings, bearings, joints, rivets, pins or the like or metallic weights embedded in the plastics material forming the handle portions to provide balance, and better “feel” in the hand for the pliers in use, such as for example, to provide increased weight allowing greater force to be exerted by the pliers.

In some embodiments, one of the handles is provided with a cavity, chamber, recess, bore or similar. Typically, the bore etc. is located at or towards the distal end of the handle or handle portion of one of the pivotal members. More typically, a current or voltage detecting or sensing device is located within the cavity for detecting whether the conductor is live. Even more typically, the detector is a volt stick having a visual indicator, such as a light, for indicating when a conductor is live by glowing when the detector or sensor is in contact with the live conductor. Even more typically, a power source, typically in the form of a storage battery or similar is provided in the cavity in the handle portion to power the volt stick or similar detector or sensor.

Typically, the jaw insert retaining portion for receiving the insert in use is provided at or towards the operative end or work end of the pliers i.e. in the jaws at the end of one or both arms or limbs of the pliers known as the nose or head of the pliers. In some embodiments, there is a single jaw insert retaining portion whereas in other embodiments, there are two jaw insert retaining portions, one located on each arm of the tool, typically at the jaw end of each arm. If there is a single jaw insert on one member, there is an anvil or similar on the other member to provide a reaction surface for the cutting element to assist in severing the conductor located between the cutting element and the anvil. Other inserts for other purposes can be provided at the head or nose of the pliers.

In one embodiment, the jaw insert retaining portion is a seat or similar cavity, chamber, void, compartment, recess, rebate, grove, space, gap or the like for receiving therein the insert which is preferably made from metal. Typically, the retaining portion is provided with one part of a locating assembly or arrangement for cooperatively engaging with the insert to correctly locate and orient the insert in the seat. In one embodiment, the jaw insert retaining portion has a locating portion which is complementary to the location portion of the insert so that the two locating portions cooperatively interact with each other to locate the insert in the recess in the correct orientation and/or to maintain the insert in the correct position.

The insert of the present invention is replaceable and/or exchangeable so that when damaged, worn or the like, the insert or part of the insert can be replaced by a new insert or a new part of the insert thereby saving the expense of replacing the entire pliers. Preferably the insert is made from metal, more preferably hardened metal.

The insert can take a number of different forms. In one embodiment, the insert includes a work element for performing a work operation on a material. One example of the work element corresponds to the jaw located at the head or nose of the pliers and has a cutting portion, a gripping portion and a jaw portion or holding portion whereas another form of the insert is a cutter, particularly a cutter for severing wire conductors located adjacent the cutter i.e. electrical wires, cables or the like. The insert can include in some embodiments, a locating portion for locating the insert in the retaining portion to assist in replacing a worn or damaged insert with a new insert by locating and maintaining the insert in the correct position and orientation.

In another embodiment, the insert is a jaw comprising a gripping element for holding the wire conductor prior to and/or during severing of the conductor, a cutting element for severing the conductor and a locating portion for locating the insert in the recess. In some embodiments, the insert further includes a holding portion including an opposed tapering surface or similar, such as a tapered flat jaw piece located at or towards one end of the insert.

In other embodiments, the insert comprises a cutting element and a locating portion. Other forms of the insert are possible, such as to install fittings on the cables, including connectors, terminals, lugs or the like.

In embodiments of the pliers having two inserts, the metallic inserts are arranged with respect to the retaining portion so that the cutting elements of each insert are at least partially in face to face opposed relationship with each other so as to be able to move into close abutting relationship with each other in response to movement of the handles to sever wire located between the cutting elements. Preferably, the cutting elements are cutters, blades or the like. More preferably, the cutters are hardened. Even more preferably, the surface of the cutters are tapered, bevelled or the like presenting a cutting surface, ridge, point, or the like to engage the material being cut in order to assist in cutting the material.

The replaceable insert is retained within the receiving portion by suitable fasteners. Suitable fasteners include threaded fasteners such as for example threaded studs, threaded adapters, grub screws, alien screws, or screws having a hexagonal shape socket or slot or similar.

In one embodiment, the locating portion of the replaceable insert is one or more apertures, grooves or bores or similar for receiving guide elements in the form of pins extending from the inner surface of the retaining portion to locate the insert correctly and accurately within the seat in the correct orientation.

In some embodiments, the inserts have a generally planar body portion in which the apertures are located. Additionally, the cutters or cutting surfaces are generally planar or prismatic extending substantially perpendicularly from the planar body portion, preferably from one side of the body portion. The work end of the tool is provided with a cap, cover, shroud, sheath, wrap, facing or similar designed to fit over the work end of the tool, particularly over the metal end of the tool or over the insert or both to provide protection against coming into contact with the exposed metal by providing insulation. Typically, the cap is removable or is fixed. If fixed, the cap is moulded around the insert.

One aspect of the present invention relates to the manner in which the insert is received within the seat at the work or operative end of the tool, i.e. at the head or nose of the tool. As the seat is in the form of a recess, when the insert is received in the recess, the one or both side walls of the recess extend along the length of the cutter which in one embodiment is a flange forming a wall of the cutter or or the cutting surface of the cutter so that almost all of the wall or flange of the cutter is covered by the wall of the recess so that only the actual cutting surface of the cutter is exposed above the side wall or side walls of the recess. As the side wall is made from a plastics material, it is insulating, so that this arrangement of flange against wall provides protection against accidentally or inadvertently touching the flange or side of the insert since most of the flange is located below the level of the wall of the recess and the wall of the recess is made from insulating material.

As the cutting surface or cutting profile of the cutters only are exposed, the tool can be used to sever live electrical conductors located between the cutters without there being a substantial risk of parts of the body, most notably the fingers, coming into contact with the insert which is the only live part of the tool.

In another aspect, a plastic cap is fitted over the metal work end of the pliers at the head or base of the pliers to insulate the work end by substantially covering the work end. The plastic cap is secured to the metal work end by a suitable fastener. In other embodiments, the plastic cap is moulded over the metal jaw.

### BRIEF DESCRIPTION OF THE DRAWINGS

The present invention will now be described by way of example with reference to the accompanying drawings in which:

FIG. 1 is a perspective view of one form of the pliers of the present invention showing one form of the replaceable insert located in place at the work end of the pliers, and

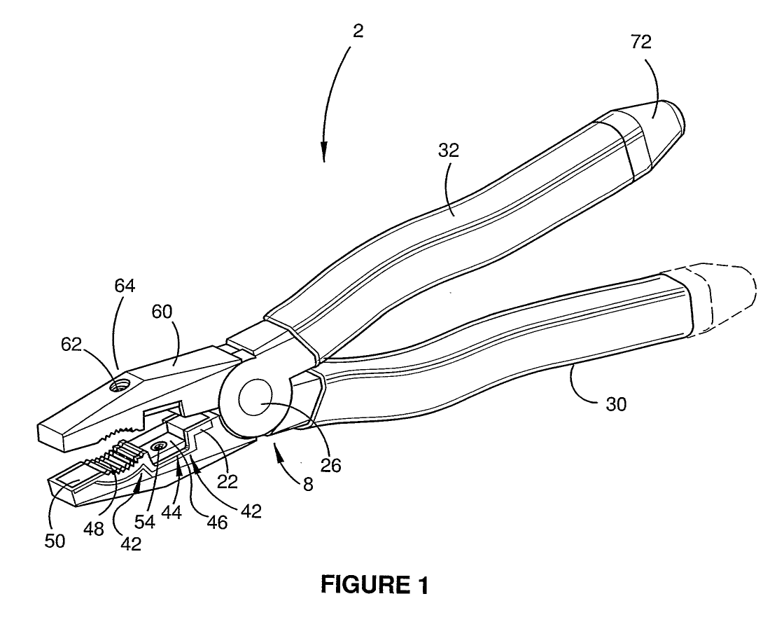

FIG. 2 is a longitudinal section view of the form of the pliers shown in FIG. 1 in section through the centre line of the pliers showing one form of the internal construction of the pliers.

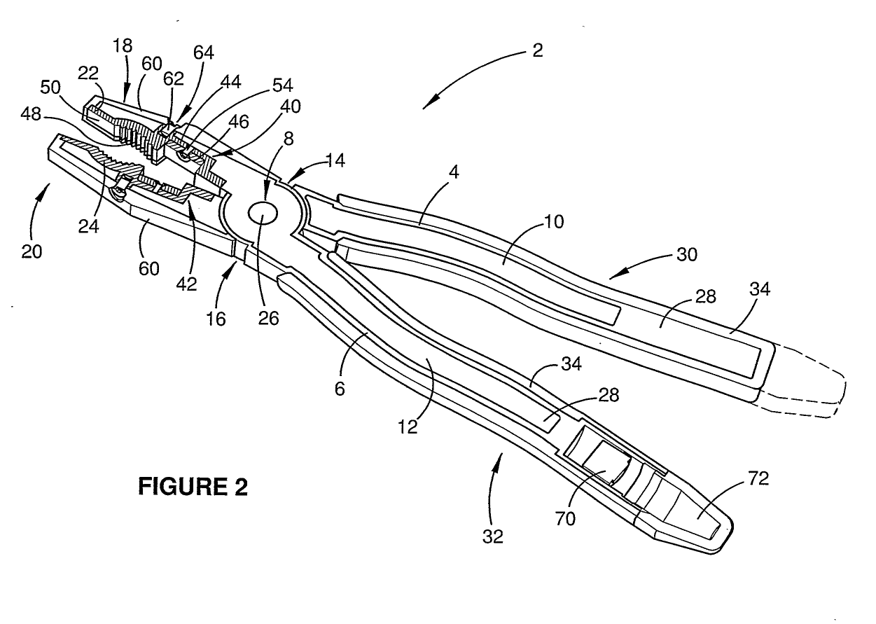

FIG. 3 is a perspective view of one form of a replaceable insert including a cutter for use with the insulated pliers of the present invention.

### DETAILED DESCRIPTION OF THE INVENTION

In one form, an embodiment of the gripping tool of the present invention is pliers, particularly insulated pliers, such as a lineman's pliers or similar generally denoted as 2 in the drawings. The pliers 2 comprise a framework arrangement comprising a pair of substantially elongate members in the form of limbs or arms 4,6 made from metal which are each pivotally joined one another at a pivot or fulcrum 8 allowing relative pivotal movement of the two arms 4, 6 with respect to each other. Each arm 4, 6 has a tang or similar end or tail portion 10, 12 located at or towards one end of pliers 2, a central section 14 , 16 forming part of the fulcrum or pivot 8, each central section being provided with an aperture in alignment with each other, and a work end 18, 20 respectively forming the head or nose of the pliers for receiving one form of a respective insert 22, 24 to hold and maintain the insert 22, 24 in place as will be described in more detail later in this specification. Thus tang 10, central section 14 and work end 18 are all integral with each other and form one metallic framework arm 4 of the pliers. Tang 12, central section 16 and work end 20 are all integral with each other and form the other metallic framework arm 4 of the pliers for co-operatively operating with each other about a suitable fastener. A pin 26 or other suitable fastener such as a peg, rivet or similar, connects the two arms 4, 6 to each other by being received within the aligned apertures of the central sections 14, 16, thus allowing arms 4, 6 to pivot with respect to each other between an open centrifugation in which the respective work ends are further apart from each other and a work configuration in which the respective work ends grip an item located there between at the head of the pliers.

Other forms of the gripping tool are also possible for a range of different purposes or for performing a range of different tasks or operations by having different work ends. Although one form of the insert is illustrated in the drawings, other forms of the insert are possible as will be described later in this specification. Also, an insert can be provided on one arm only or on both arms depending upon circumstances and the type of pliers.

Tangs 10, 12 of arms 4, 6 are made from metallic material and are thus electrically conducting. An inner supporting core 28 of insulating material is moulded or otherwise formed over around or to tangs 10, 12 to form the internal structure of handles 30, 32 by fully enveloping and surrounding the metal tangs 10, 12. The core layer 28 is made from an electrically insulating material, generally an electrically non-conductive plastics material, such as an engineering plastics material or similar. A particularly preferred form of the plastics is glass filled nylon. However, any suitable non conducting engineering plastics material having acceptable strength, durability and rigidity properties can be used.

An outer covering layer or coating 34 is provided outboard of core 28 to form an insulating cover or covering over plastic handles 30, 32 to provide additional insulation and to protect the plastic handles 30, 32 against damage or breakage and to protect and/or preserve insulation of the tool and/or core 28. One form of the material from which the insulating cover 34 is made is an elastomeric material. The covering may be made from any suitable material including resiliently deformable material, ‘soft-feel’ material, rigid material or the like depending upon the type of ‘feel’ required of the pliers when in the hand.

Handle 32 is provided with a detector or sensor located at or towards the distal end for detecting or sensing whether a conductor is live i.e. carrying current. In one form, the detector or sensor is in the form of a detector for detecting a potential difference, current or the like.

Preferably, the detector is a volt stick or similar for detecting potential difference. The volt stick includes battery 70 and visual indicator 72. Any arrangement or suitable type of battery and detector may be used, including a rechargeable battery or the like.

In another embodiment, handles 30, 32 are made entirely of suitable plastics material i.e. engineering plastics materials. In one embodiment, each of the central sections 14, 16 are made from non conducting plastics materials whilst the sections at either end being the metallic tangs at one end and the metallic work ends at the other end are made from metal. In other embodiments, pivot 8 can be made of metal such as for example, pivot 8 being made of metal bushes, sleeves, collars, rivets, pins, pegs or the like with one part inserted into or received within another part and a pin or other retainer being received through the aligned apertures of the respective central sections. In this embodiment, an insulating layer or cover is provided over the exposed metal surfaces of the central sections, fulcrum, pin or the like. The insulating layer can be a continuation of core 28 or part of outer covering 34 or can be a separate insulating covering made from the same or different materials as core 28 or covering 34. In still other embodiments, insulation material or other material can be provided in the form of a cap, skirt or shroud (not shown) which is fitted over pivot 8 on both sides preventing any exposed metal part coming into contact with a workman's hands or fingers, particularly the thumb when using the pliers to strip the insulation from the end of a live wire prior to joining the wire to another fitting or wire. If a covering or shroud is fitted, the arrangement should be such so as to allow pliers 2 to pivot about pivot 8 and hence be used without the covering or shroud interfering or fouling operation of the pliers. Each operative end 18,20 of arms 4,6 is provided with an insert receiving portion in the form of a rebate, chamber, cavity, recess or similar, namely a seat 42, into which insert 22,24 is received to form the jaw sections of arms, 4 ,6.

A replaceable or exchangeable insert 22, 24 is located within seats 40, 42 respectively provided at the work ends of arms 4, 6. It is to be noted that replaceable or exchangeable insert 22, 24 is located to one side of the work end of each arm. As both sides of pliers 2 are the same, only one side will be described in detail, the other side being a mirror image. One form of seat 40 acting as insert retaining portion for receiving the insert is a generally elongate complex shaped recess formed at or towards the head or nose of pliers 2 as a seat or recess having a profile including a multitude of grooves, rebates, cut-outs, crests, plateaus, shoulders, rebates, rabbets and the like in generally stepped relationship to one another corresponding to the shape of the non operative side of the insert being the inboard side of the insert when received in the recess. The profile or shape of recess 40 is matched very closely to the inboard profile or shape of the inner side of insert 22. Insert 22 is closely fitted into recess 40 so as to seat matchingly in seat 40. In one form, seat or recess 40 is formed from metal being made integral by with arm 4, whereas in another form, recess 40 is made from plastics material which is moulded to or around the work end of the metal arm 4.

In the embodiment of the insert 22 as illustrated in the drawings, insert 22 has a number of separately identifiable portions which can best be described as a cutting portion 44 having a cutting surface or blade 45 formed at or towards the end of a flange or wall 45 or the like ending in a ridge and having two converging sloping walls 47 located more inwardly, a centrally located gripping portion in the form of a generally concave serrated gripper 48 having a multitude of spaced apart teeth 49 and a more outwardly located extension or holding portion 50 in the form of a flat section located at the distal end of the work end 18 of arm 4 to form one of the jaws of pliers 2. In one embodiment of insert 22, cutting portion 44 is additionally provided with a replaceable cutter 46 fastened to the cutting portion 44 by a suitable fastener in the form of screw 54 so that not only can the insert be replaced but also the cutter 46 can be replaced independently of the insert. In another embodiment the cutting portion 44 is integrally formed with the remainder of the insert and is provided with a fixed cutter 46 which necessitates the entire insert being replaced if the cutter is damaged, worn, blunt or the like. Insert 22 is provided with an internally threaded bore or blind hole or similar for receiving a suitable fastener such as an externally threaded fastener therethrough. One example of the fastener is screw 62. In the embodiment having the fixed cutter, the entire insert 22 is replaced using screw 62 whereas in the embodiment having the replaceable cutter, either the cutter itself using screw 54, or the insert using screw 62, can be separately replaced depending upon whether only the cutter is damaged or whether the cutter and insert are both damaged. In the event that insert 22 is moulded to the plastics material forming the work end of the tool, only cutter 46 is replaceable using screw 54 since the insert is fixed in place against the plastic wall of the insert retaining portion such as by the flange 45 of the cutter 46 being moulded to the wall of the recess.

Cutter 46 can take any suitable form or arrangement depending upon the nature of the material being cut by the cutters and the application of the pliers.

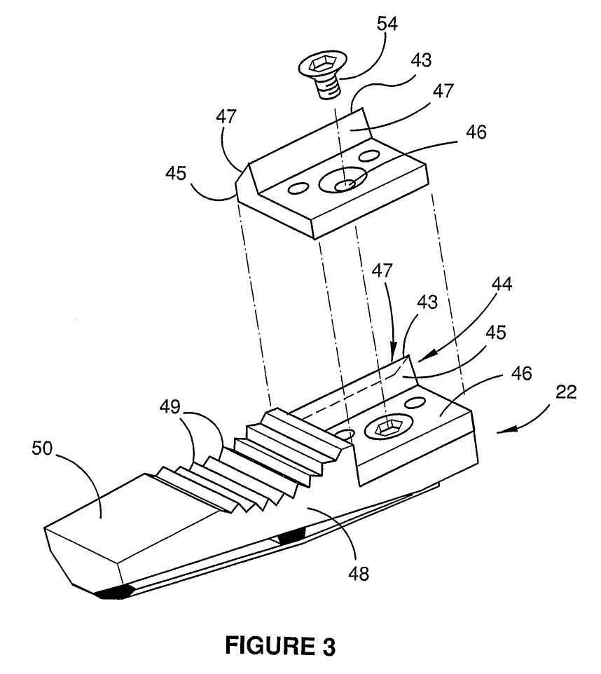

With particular reference to FIG. 3, one preferred form of insert 22 is illustrated with a generally rectangular pyramidal portion comprising flange or wall 45, a pair of converging sloping walls 47 and a ridge forming a cutting surface 43 located toward one side of generally outwardly insert 22. The distal edge of the ridge is in the form of a cutting blade. One form of the blade includes a generally tapered or bevelled edge forming a sharp edge for engaging with a wire conductor to cut the conductor in use when located between the two cutters 46 on either arm 4, 6 of the pliers. A fastening aperture 51 is centrally located for receiving screw 54 therethrough to secure cutter 46 to insert 22. Other forms or shapes of the cutter and blade are possible.

A plastic cap 60 or similar cover is fitted over the outboard end of work end 18 of arm 4 and secured thereto by fastener 62 being received through a recessed aperture 64 provided in the body of cap 60. The walls and ends of cap 60 cover the metal parts of the work end of arm 4 and the side wall parts of the insert 22. Cap 60 can take any suitable configuration or shape. It is to be noted that the sidewalls of cap 60 extend to such an extent to cover the side walls of insert 20 whilst leaving the end or edge of cutter 46 or its blade 43 exposed to allow the blade to sever the wire conductor. In other embodiments, cap 60 can take other forms by being moulded to or around the end of the arm 4 and insert 22. Alternatively, plastic cap 60 is fixed in place by being moulded directly to insert 42.

In one form, cutter 46 is also provided with one or more suitable locating elements (not shown). One example of the locating elements is a pair of spaced apart locating apertures which are typically located on either side of the fastening aperture and to one side of body. The two locating apertures are arranged so as to receive a pair of spaced apart pins or other suitable complementary locating elements therein so as to correctly orient the insert when the locating pins and locating apertures are respectively aligned with each other.

It is to be noted that when insert 22 is in seat 42, cutter 46 is exposed as is the more distal end of the flange.

In operation of this form of the pliers, when a live conductor is to be cut, the pliers are located around the wire so that as force is applied to the cutters to force them closer together, the cutters sever the wire. If the wire is live, there is usually a small explosion accompanied by heat being generated with sufficient intensity to damage the inserts 22, 24 and/or cutters 46, particularly blades 43 or the top of the ridge forming the cutting surface often to such an extent that the inserts and/or cutters require replacing. To replace the damaged inserts, fasteners 62 securing the inserts 22, 24 in recess 42, 44 are removed so that the damaged insert can be removed from seats 42, 44 respectively. A new insert 22 can then be placed in seat 42 and a new insert 24 can be located in seat 44. When the insert is correctly located, the fastener 62 is inserted into the fastening aperture of the insert and tightened to secure the insert after passing through aperture 64 and cap 60.

In the event that cutter 46 only is to be replaced, screw 54 is unfastened to allow cutter 46 to be removed from cutting portion 44 whilst insert 22 remains in place. A new cutter 46 is located within cutting portion 44 in the correct location and screw 54 tightened to secure cutter 46 in insert 22.

A modified form of the tool of the present invention (not shown) is provided with a replaceable insert 22 on one arm and an anvil or similar support on the other arm. The cutter blade 43 engages against the anvil in use to sever a wire located therebetween. In this embodiment, only a single insert 22 need be replaced when damaged. In another modification, the anvil can be a planar member embedded below or at the level of the side wall of the work portion of the tool at the head or nose of the tool so as to not extend above the plastic wall of the recess of the tool in which the anvil is received. In a still further embodiment, the anvil is replaceable being secured in a suitable recess by a suitable fastener in a manner similar to the insert being located in the recess.

Another modified form of the tool has metal weights embedded in the plastics material forming the handles of the tool. The metal weights are incorporated to improve the balance of the tool and to provide additional “hand feel” of the tool so as to make the tool more comfortable and easier to use. If the metal weights are present, it is to be noted that the weights are electrically isolated from the metal jaw insert, and preferably from each other to avoid the possibility of electrocution of someone holding the tool when it contacts a live conductor. In these embodiments, the metal weights are more or less completely surrounded by insulating plastics material and are generally spaced apart from each other.

### ADVANTAGES OF THE INVENTION

Advantages of the present invention include that there is no electrical connection between the jaw portion or fulcrum of the tool and the handle portion, thereby preventing injury and electrocution to a person using the tool when it comes into contact with a live wire.

Damaged inserts and/or damaged cutters can be readily replaced, thereby obviating the need to obtain new pliers or other hand tools.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A hand held gripping tool having a first member and a second member pivotally connected to one another about a pivot allowing relative movement of the two members with respect to one another, each said member having an operative end and a handle portion arranged so that the respective operative ends are moved relatively closer together towards each other in response to movement of the handle portions relatively closer together toward each other characterised in that at least one of the operative ends includes an insert retaining portion for receiving an insert therein wherein the insert retaining portion is at least partially insulated from the operative end of the member so that if the insert when received in the retaining portion contacts a live electrical conductor, there is a reduced chance of live electrical current being conducted from the insert through the tool to the handle portion of either member thereby providing improved safety for the person holding the tool by protecting the person holding the hand held tool against injury that could have been caused by contact with the live electrical conductor.

2. An insert for a hand held tool characterised in that the insert comprises a main body portion having at least one work element extending outwardly from the body portion for performing a work operation on material located adjacent the work element in use of the tool and a fastening arrangement for assisting in fastening the insert to the tool wherein the tool is provided with a retaining portion for receiving the insert therein so that the insert is at least partially insulated when received in the retaining portion.

3. A tool or insert according to any preceding claim characterised in that the insert further includes a locating portion for locating the insert with respect to the tool such that the locating portion of the insert engages with a complementary locating element provided on the tool to correctly orient the insert with respect to the tool in the position in which at least a part of the work element of the insert is exposed to perform the work operation.

4. A tool or insert according to any preceding claim characterised in that the locating portion for locating the insert is located within the insert retaining portion of the tool.

5. A tool or insert according to any preceding claim characterised in that the tool is a hand held gripping tool including pliers, stripping tools, tweezers, locking pliers, clamps, tongs, forceps, shears, hand cutting tools, wire cutters, crimping tools, grips or similar.

6. A tool or insert according to any preceding claim characterised in that the tool is a cutting and/or severing tool or a crimping and/or squeezing or clamping tool, or is a tool having a combination capable of performing cutting and squeezing operations.

7. A tool or insert according to any preceding claim characterised in that the members, arms or limbs of the tool are made from an insulating material or at least partially made from an insulating material or made from a combination of insulating and conducting materials or are entirely or partially covered by an insulating material.

8. A tool or insert according to any preceding claim characterised in that the insulating material from which one or more of the parts of the hand tool are made is an engineering plastics material having sufficient strength, durability and rigidity, including materials such as polyamides, nylons, polyethylene, polypropylene, acrylonitrile butadiene styrene, polybutylene, polyvinyl chloride, polyvinylidene fluoride, chlorinated polyvinyl chlorides or other similar materials.

9. A tool or insert according to any preceding claim characterised in that the insert is insulated from the handles so as to be electrically isolated from the handles.

10. A tool or insert according to any preceding claim characterised in that one or both of the handles of the tool are provided with a cavity, chamber, recess, bore or similar located at or towards the distal end of the handle or handle portion for use in containing a current or voltage detecting sensing device for detecting whether a conductor is live.

11. A tool or insert according to any preceding claim characterised in that the detector is a volt stick having a visual indicator for indicating when a conductor is live and optionally provided with a power source including a battery or similar.

12. A tool or insert according to any preceding claim characterised in that the insert retaining portion is a jaw receiving portion for receiving the insert is provided at or towards the operative end or work end of the tool such as in the jaws at the head or nose end of one or both arms of the hand tool.

13. A tool or insert according to any preceding claim characterised in that there is a single jaw insert retaining portion or there are two jaw insert retaining portions, one located on either member of the tool.

14. A tool or insert according to any preceding claim characterised in that the jaw insert retaining portion is a seat, cavity, chamber, void, compartment, rebate, recess, rabbet, groove, space, gap or similar for receiving the insert therein.

15. A tool or insert according to any preceding claim characterised in that the insert is made from metal or includes metal parts or components, optionally covered or coated with an insulating material.

16. A tool or insert according to any preceding claim characterised in that the insert is replaceable and/or exchangeable by being readily detachable or demountable from the jaw insert retaining portion by use of a releasably securable fastener.

17. A tool or insert according to any preceding claim characterised in that the insert is a cutter having a cutting surface or is a cutter having a blade.

18. A tool or insert according to any preceding claim characterised in that two insert are arranged with respect to each of the jaw insert retaining portion so that the respective cutting elements of the insert are in face to face opposed relationship with each other so as to cooperatively interact with one another to cut or sever material located between the inserts in use of the tool.

19. A tool or insert according to any preceding claim characterised in that the replaceable insert is retained within the jaw insert retaining portion by suitable fasteners including threaded fasteners, removable fasteners, demountable fastenings, or the like.

20. A tool or insert according to any preceding claim characterised in that the locating portion of the replaceable insert includes one or more apertures, grooves, bores, troughs, depressions, indentations or similar for receiving projections in the form of pins or locating guides or similar therein extending outwardly from the plane or one of the planes of the inner surface of the retaining portion to locate the insert correctly and accurately within the seat in the correct orientation.

21. A tool or insert according to any preceding claim characterised in that the insert receiving portion is a seat in the form of a recess arranged such that when the insert is received in the seat, the side walls of the recess extend along the length of the wall forming a flange of the insert so that almost all of the wall of the flange of the insert is covered by the wall of the recess so that only the cutting surface or cutter portion or blade of the insert is exposed above the side wall of the recess thereby reducing the exposure of the cutting part of the insert to direct touch by a person using the tool.

22. A tool or insert according to any preceding claim characterised in that the side wall of the recess is made from an insulating material so protect the insert from contacting a live conductor in use.

23. A tool substantially as hereinbefore described with reference to the accompanying drawings.

24. An insert or a tool substantially as hereinbefore described with reference to the accompanying drawings.
